(19) United States
(12) Patent Application Publication
(10) Pub. No.: US 2025/0135480 A1
(43) Pub. Date: May 1, 2025

(54) OPERATING METHOD FOR A COATING SYSTEM, AND COATING SYSTEM FOR CARRYING OUT THE OPERATING METHOD

(71) Applicant: Dürr Systems AG, Bietigheim-Bissingen (DE)

(72) Inventors: Nico Koch, Tamm (DE); Paul Thomä, Sachsenheim (DE); Dominik Vincenz, Sachsenheim (DE); Robin Heim, Güglingen (DE)

(21) Appl. No.: 18/682,456

(22) PCT Filed: Aug. 1, 2022
(86) PCT No.: PCT/EP2022/071520

§ 371 Date: Feb. 9, 2024

(30) Foreign Application Priority Data
Aug. 17, 2021 (DE) 10 2021 121 320.7

(51) Int. Cl. B05B 12/08; B05B 12/00; B05B 13/04

(52) U.S. Cl. CPC B05B 12/084; B05B 12/006; B05B 13/0431

(57) ABSTRACT

The disclosure relates to an operating method for a coating system for coating components (e.g. motor vehicle body components) with a coating agent (e.g. paint) by means of an applicator (e.g. rotary atomizer), including the following, The components may be coated with the coating agent, whereby component-related process values are obtained which represent operating variables of devices of the coating system during the coating of the individual components, and whereby a specific component-related coating quality results during the coating of the individual component. Component related process values of the coating system may be determined. Quality relevant anomalies in the process values may be determined. The position of the coating defects corresponding to the anomalies may be determined.

### CROSS-REFERENCE TO RELATED APPLICATIONS

This application is a national stage of, and claims priority to, Patent Cooperation Treaty Application No. PCT/EP2022/071520, filed on Aug. 1, 2022, which application claims priority to German Application No. DE 10 2021 121 320.7, filed on Aug. 17, 2021, which applications are hereby incorporated herein by reference in their entireties.

### TECHNICAL FIELD OF THE DISCLOSURE

The disclosure relates to an operating method for a coating system for coating components (e.g. motor vehicle body components) with a coating agent (e.g. paint) by means of an applicator (e.g. rotary atomizer).

### BACKGROUND

In modern painting systems for painting automotive body components, quality control of the painting process is carried out to ensure that the painting result meets certain standards. For example, quality characteristics of the applied paint are measured, such as layer thickness, evenness, color tone, brightness, hardness, degree of crosslinking and gloss, to name just a few examples. In this way, quality defects on the paint of the motor vehicle body can then be determined. Depending on these measurements of the quality characteristics, process values (e.g. high voltage of an electrostatic paint charging system, paint flow, shaping air flow, etc.) of the painting system can then be adjusted to improve the quality of the painting process. Until now, this adjustment of the process values of the painting process to improve the quality of the painting process has been carried out manually by an expert on the basis of the expert's experience. The causes of possible quality defects are also determined manually by changing process values according to the try-and-error principle, with the influence of the change on the quality of the coating operation being evaluated in each case. This type of quality control is error-prone and heavily dependent on the experience of the expert entrusted with it.

Coating systems in which process values are determined are known from WO 2020/141372 A1, CN 112 246 469 A, EP 2 095 336 B1 and DE 197 56 467 A1. By evaluating the process values, fault conditions can then be detected. However, this is not yet completely satisfactory.

### BRIEF DESCRIPTION OF THE DRAWINGS

FIG. 1 shows a flow chart illustrating the training operation of the machine learning algorithm for detecting the quality-relevant anomalies of the process values.

FIG. 2 shows a flow chart illustrating the prediction operation during the actual painting process.

FIG. 3 shows a schematic representation of a painting system according to the disclosure.

FIG. 4 shows a screen display with a perspective view of a motor vehicle body and marking of coating defects.

FIG. 5 shows a variation of FIG. 4.

### DETAILED DESCRIPTION

The disclosure is based on the task of improving the quality control in a coating system (e.g. painting plant) for coating components (e.g. motor vehicle body components).

The operating method according to the disclosure is generally suitable for a coating system for coating components with a coating agent by means of an applicator.

In a preferred embodiment of the disclosure, however, the coating system is a coating system for coating motor vehicle body components with a paint, wherein an atomizer (e.g. rotary atomizer) can be used as the applicator.

However, the disclosure is not limited to paints with regard to the applied coating agent. Rather, the applied coating agent can also be an adhesive, a sealant or an insulating material, to name just a few examples.

Furthermore, the disclosure is not limited to an atomizer with respect to the type of applicator. Rather, a different applicator can also be used within the scope of the disclosure, such as a print head or a so-called sealing applicator.

Furthermore, with regard to the components to be coated, the disclosure is not limited to motor vehicle body components which are painted in the preferred embodiment of the disclosure. Rather, the operating method according to the disclosure is generally suitable for coating components of different types.

In the operating method according to the disclosure, components (e.g. motor vehicle body components) are coated with a coating agent (e.g. paint) in accordance with the state of the art. During this coating operation, component-related process values (e.g. paint flow, shaping air flow, charging voltage of an electrostatic paint charging system, etc.) are generated, which reflect operating variables of devices of the coating system during the coating of the individual components. In addition to the process values mentioned above as examples, a wide range of process values can be generated and evaluated, as will be described in detail later.

During the coating of the individual components, a component-related coating quality results in each case, i.e. the individual components are coated with an individual coating quality.

The disclosure provides that the component-related process values of the coating system are at least partially determined. This means, for example, that during the painting of a motor vehicle body, the process values with which this motor vehicle body is painted are determined. This then enables quality control, as will be described in detail.

In addition, the disclosure preferably provides that component-related quality values are then determined for the individual coated components, which reflect the coating quality of the individual components. Thus, at least one quality value or preferably a set of quality values is determined for each coated component.

The disclosure now additionally provides that quality-relevant anomalies of the process values are determined in order to be able to detect coating defects during the coating of the individual components in the course of a prediction operation during the coating of the components. In the context of the disclosure, the determination of coating defects should therefore not only be carried out by evaluating the measured quality values, i.e. in retrospect, but also in advance by determining quality-relevant anomalies in the process values. The determination of the quality-relevant anomalies of the process values within the scope of the prediction operation is preferably carried out by means of a machine learning algorithm, i.e. by means of artificial intelligence (AI).

Furthermore, the disclosure provides that the position of the coating defects corresponding to the quality-relevant anomalies on the component surface of the coated components is determined by an evaluation of the process values. It is thus determined which position on the component surface was just coated when the quality-relevant anomalies of the process values occurred.

When evaluating the process values, on the one hand the quality-relevant anomalies that can lead to coating defects are determined. On the other hand, the position of the coating defects on the component surface is also determined. The determination of the position of the coating defects on the component surface facilitates the defect removal and enables a graphic representation of the coating defects on a screen, as will be described in detail. The correlation between the coating defects on the one hand and the quality-relevant anomalies of the process values on the other hand facilitates the optimization of the process values to improve the coating quality, so that less experience knowledge of the operator is required.

In the preferred embodiment of the disclosure, a graphical representation of the components is provided in the form of a graphical component representation on a screen. When painting motor vehicle body components, the motor vehicle body components to be painted can be displayed on the screen, for example, in a perspective view or in other views (e.g. side view, top view, rear view). The previously determined coating defects can then be marked on the graphic component representation according to the position of the coating defect. If, for example, it was previously determined that there is a coating defect on the front left fender of a motor vehicle body, this coating defect is also marked accordingly on the front left fender on the graphical representation of the motor vehicle body on the screen. This graphic representation makes it easier for the operator to detect the defect and eliminate it by adjusting the process values accordingly.

It should be mentioned here that the graphical representation of the component on the screen can be, for example, two-dimensional (e.g. top view, side view, rear view or front view) or three-dimensional (perspective view).

The determined quality-relevant anomalies of the process values are preferably stored together with the associated quality values in a database, which enables an evaluation.

It has already been briefly mentioned above that the determination of the quality-relevant deviations of the process values is preferably carried out by a machine-learning algorithm which can be trained in the course of a training operation. This training operation of the machine-learning algorithm preferably takes place before the actual prediction operation, i.e. separately from the actual painting process. However, it is also possible that the training operation of the machine-learning algorithm takes place during the prediction operation, i.e. during the actual painting process. Furthermore, it is possible that a training operation takes place before the actual painting process in order to train the machine-learning algorithm. The machine-learning algorithm can then be further optimized during the normal painting process.

The training of the machine learning algorithm in the training mode usually comprises several steps. First, process values are determined for a coating operation. In addition, the associated quality values are determined for the coating operation. The determined process values and the determined quality values are then stored in an assignment in a database. Subsequently, the machine learning algorithm can then be trained using the process values stored in the database and the quality values stored in the database.

In addition, the disclosure preferably also provides that an optimization proposal is determined which specifies how the process parameters can be optimized to avoid a coating defect that has occurred. The optimization proposal is preferably determined automatically and preferably also implemented automatically. If, for example, the analysis of the process values and the analysis of the coating defects shows that the coating flow was too high, the optimization proposal could provide that the coating flow is reduced. Furthermore, the optimization proposal is preferably also indicated visually. Thus, within the scope of the disclosure, it is also possible that the optimization proposal is only displayed, whereupon the operator of the coating system can then decide whether he accepts and implements the optimization proposal.

The term process values used in the context of the disclosure is to be understood in a general sense, and may include target values and/or actual values of the operating variables of the individual devices of the coating system.

For example, the process values can be at least one of the following operating variables of the coating system:
Drive variables of a robot drive for driving a coating robot, in particular target value and/or actual value of position, angle, speed and/or torque,
path data of a robot movement, in particular target values and/or actual values of path position and/or path speed of the applicator in space along a robot path,
pump variables of a coating agent pump, in particular target values and/or actual values of flow rate of the coating agent, delivery rate of the coating agent, pump speed, torque of a pump drive,
operating variables of a metering piston of a metering pump, in particular target values and/or actual values of the position of the metering piston, pressure at the inlet or outlet of the metering pump, flow rate through the metering pump, torque of a pump drive,
pressure measurement values of a pressure sensor, in particular coating agent pressure upstream of a coating agent pump, coating agent pressure downstream of a coating agent pump, coating agent downstream of a metering piston,
valve variables of a valve, in particular target values and/or actual values of a coating agent valve for controlling the flow of coating agent, in particular in a valve for controlling the flow of paint, solvent, water, sealant, insulating materials or adhesives,
operating variables of an air pressure regulator, in particular target values and/or actual values of pressure, flow rate of media, in particular of shaping air, atomizing air, horn air or free-flow air,
operating variables of a speed controller, in particular target values and/or actual values of speed, motor air pressure, motor air quantity in a rotary atomizer,
operating variables of a paint pressure controller, in particular target values and/or actual values of paint pressure and/or flow rate,
operating variables of an electrostatic coating agent charging system, in particular target values and/or actual values of voltage and/or current of the electrostatic coating agent charging system,
operating variables of a booth air conditioning system of a coating booth, in particular target values and/or actual values of air temperature, air humidity and/or air sink rate in the coating booth,
wear variables, in particular the counter reading of a wear counter or operating hours, which are preferably stored on a machine component, in particular in an RFID tag (RFID: radio frequency and identification),
actual values of proximity sensors, in particular capacitive or inductive proximity sensors,
type and properties of fieldbus devices, connection status or error counters of fieldbus systems,
actual values of temperature sensors, in particular at drives, at the applicator or at the material supply,
fault messages from the devices involved in the coating operation, in particular from application robots, handling robots, PLC/cell control, cleaning devices, conveyor technology, booth conditioning and/or, pre-treatment,
workpiece identification numbers to identify the components to be coated,
properties of the coating agent, in particular color, color number, color code, adhesive type, viscosity, storage temperature, application temperature, batch,
Time stamp of the recording times of the operating variables.

It should be mentioned here that any combination of the above-mentioned operating variables can be evaluated as process values. In practice, a complete set of numerous operating variables is evaluated as process values and taken into account in quality control.

Furthermore, it should be mentioned that the components to be coated are preferably coated in several coating tracks running side by side, as is known per se from the prior art. The coating tracks running next to each other then overlap at their edges and form a continuous coating film on the component. The process values can be determined individually for the individual coating tracks in order to be able to carry out quality control for each of the coating tracks individually. However, it is also possible for the process values to relate in each case to the currently coated coating track and at least one of the adjacent coating tracks.

It has already been mentioned above that, within the scope of the disclosure, quality values are determined which reflect the quality of the coating operation. For example, these quality values may be at least one of the following quantities:
Number of coating defects in the respective component,
position of the coating defects in space, in relation to the component or in relation to the coated partial surface,
type of the coating defects.

Furthermore, it should be mentioned that the disclosure does not only claim protection for the above-described operating method according to the disclosure. Rather, the disclosure also claims protection for a coating system which is suitably designed to carry out the operating method according to the disclosure.

To this end, the coating system according to the disclosure firstly comprises at least one applicator (e.g. rotary atomizer) which is used to apply the coating agent (e.g. paint) to a component (e.g. motor vehicle body component).

Furthermore, the coating system according to the disclosure comprises at least one coating robot to move the applicator.

The coating robot and the applicator are controlled by a control system, which is known from the prior art.

The disclosure now provides that the control system is designed to carry out the operating method according to the disclosure. For this purpose, a corresponding control program is usually stored in the control system, which, when executed on the control system, carries out the operating method according to the disclosure.

It should be mentioned here that the control system preferably has several different system components which fulfill different functions. The individual system components may here also be concentrated as software modules in a single computer. However, it is alternatively also possible that the individual system components are realized as separate hardware components.

For example, the control system of the coating system according to the disclosure may have the following system components:
At least one robot controller for controlling the coating robot, the robot controller or an additional acquisition device supplying at least some of the process values,
at least one further control system in addition to the robot control system, in particular in the form of a cell control system, which controls a robot cell, this further control system supplying at least a part of the process values,
a database computer with a database for storing the process values and the associated quality values,
a quality value computer for manual or automatic acquisition of the quality values,
a connection computer, the connection computer receiving the process values from the at least one robot controller and/or from the further controller and forwarding them to the database computer, and receiving the quality values from the quality value computer and forwarding them to the database computer.
an AI computer which receives the process values and the associated quality values from the data-base computer and determines the quality-relevant anomalies of the process values and the associated position on the component by means of the machine learning algorithm, and sends the determined quality-relevant anomalies to the database computer for storage in the database,
a display computer for graphical representation of the coating defect on the graphical component display corresponding to the position of the coating defect on the component surface.

The recognition of the correlations between the recorded process values and the quality data is preferably carried out by training a binary or multi-class classifier (multi-class in the sense of classifying different types of coating defects, e.g. lean, crater, etc.).

The assignment of process values to the measuring points of the quality measurements is preferably carried out via the robot paths, which are also recorded. For a quality measurement point, the process values for which the distance of the applicator to the measurement point does not exceed a defined measurement value are preferably considered as explanatory features.

This results in an assignment of time series to quality measurements. For simplification, aggregations can be formed from the time series to reduce the complexity of the classifier.

In addition to the process values assigned via the robot paths, other features can be included via the classifier, such as the maintenance condition of individual components, booth condition (especially temperature, humidity).

The following machine learning algorithms are particularly suitable for the classifier: gradient boosting, LSTM (long short-term memory), artificial neural network, SVM (support vector machine).

The calibration as well as the actual execution of the training process is preferably performed using the mentioned software tools according to “best practices” for training a classifier, i.e. the disclosure does not require a novel procedure in this respect.

Other advantageous further embodiments of the disclosure are indicated in the dependent claims or are explained in more detail below together with the description of the preferred embodiments of the disclosure with reference to the figures.

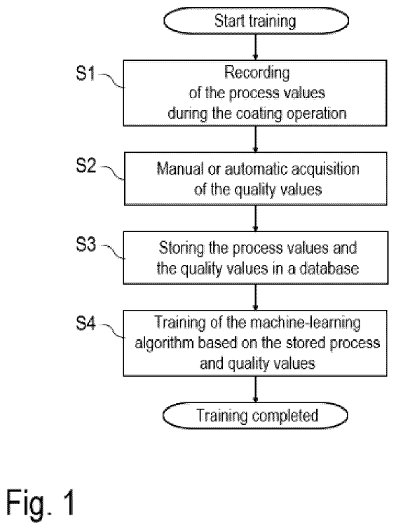

In the following, we will first describe the flow chart according to FIG. 1, which shows the training operation of the machine learning algorithm. The task of the training operation is to enable the machine learning algorithm to recognize the quality-relevant anomalies in the process values.

In a first step S1, process values are measured and recorded in a coating operation. The process values can be a variety of operating variables of devices involved in the coating operation. For example, it can be the paint flow, the shaping air flow, the charging voltage of an electrostatic paint charging system or the path speed of the painting robot, to name just a few examples. Preferably, however, a large number of different process values are measured and recorded in order to make the evaluation of the process values as meaningful as possible.

In a further step S2, quality values are recorded that reflect the quality of the coating operation. For example, these quality values can reflect the coating thickness, evenness, color tone, hardness, gloss level or other properties of the applied coating.

In the next step S3, the previously determined process values are then stored in a database together with the likewise determined quality values in an assignment to one another. For example, the process values and the quality values can each be stored with a time stamp, which facilitates subsequent evaluation.

The machine-learning algorithm can then be trained on the basis of the process values stored in the database and the quality values also stored in the database, in order to be able to detect quality-relevant anomalies in the process values.

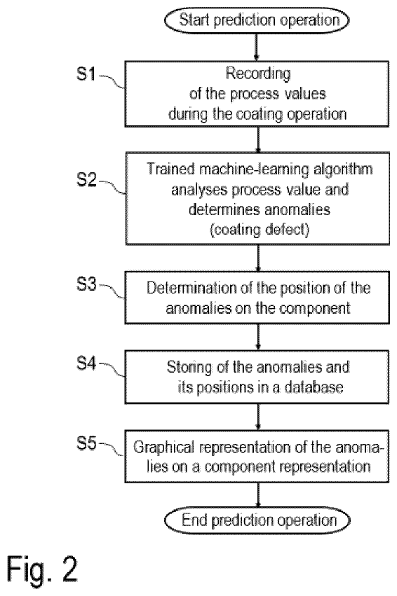

In the following, the flow chart according to FIG. 2 is described, which describes the actual prediction operation that takes place during the actual painting process.

In a first step S1, process values are again measured and recorded, with these process values occurring during the normal painting process.

In the next step S2, the previously trained machine learning algorithm then analyzes the measured process values and determines quality-relevant anomalies that indicate coating defects.

In a further step S3, the position on the component is determined which is to be assigned to the quality-relevant anomalies of the process values.

Subsequently, the determined anomalies of the process values are stored in a database together with the position on the component in a step S4.

In the next step S5, the anomalies of the process values are displayed graphically on a component display to enable the user to analyze the error and to facilitate troubleshooting.

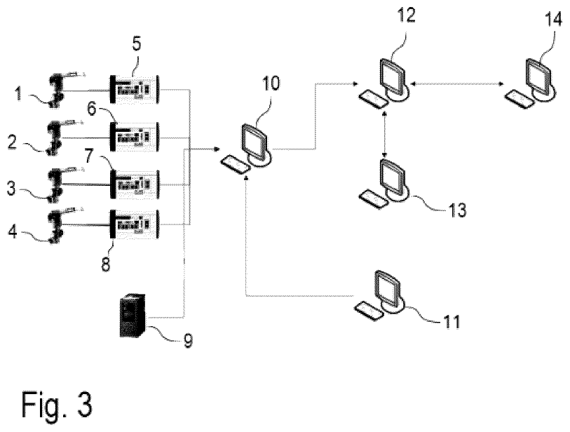

In the following, the schematic representation of a painting system according to the disclosure is described in FIG. 3.

The painting system according to the disclosure comprises several painting robots 1-4, each of which is controlled by a robot controller 5-8.

In addition, a separate cell controller 9 is provided, which controls the individual devices in a painting cell (paint booth) in a superordinate manner.

The robot controllers 5-8 and the cell controller 9 are connected to a connection computer 10, which enables data to be exchanged. Thus, the connection computer 10 receives numerous process values from the robot controllers 5-8 and also from the cell controller 9, such as target values and actual values of devices within the respective painting cell.

The connection computer 10 is connected to a quality value computer 11, which supplies quality values that have been measured and reflect the quality of the painting process. These quality values are essentially used to train a machine learning algorithm to detect quality-relevant anomalies in the process values.

Furthermore, the connection computer 10 is connected to a database computer 12, which receives the process values and the associated quality values from the connection computer 10.

The database computer 12 is in turn connected to an AI computer 13, in which a machine-learning algorithm determines quality-relevant anomalies of the process values and reports them back to the database computer 12.

Finally, the database computer 12 is also connected to a display computer 14, which has a screen and displays on the screen a graphical representation of the painted motor vehicle body components with any painting defects, as will be described in detail.

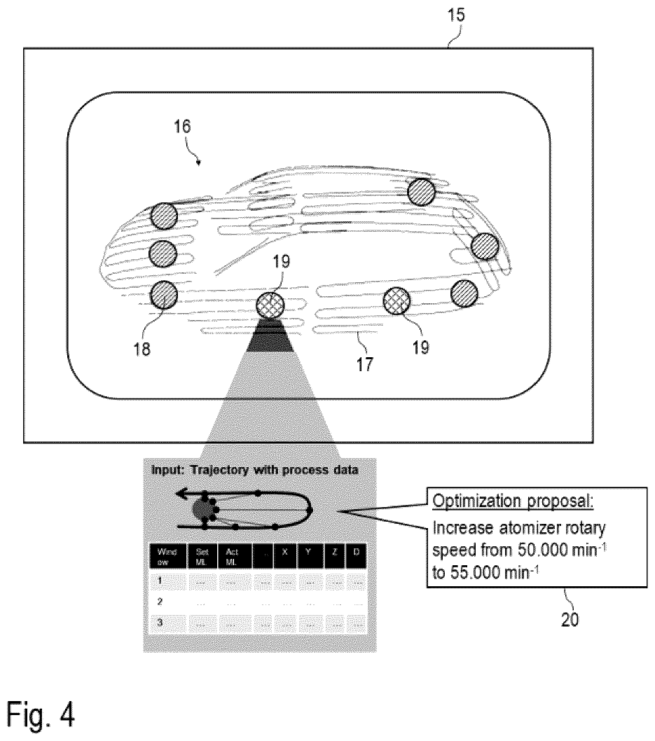

FIG. 4 shows an exemplary representation of a screen 15 of the display computer 14 with a body representation 16. Here, the individual painting paths 17 along which the atomizer paints the motor vehicle body are also graphically represented. In addition, inconspicuous points 18 and abnormal points 19 are marked on the body representation 16, the abnormal points 19 indicating coating defects with a high degree of probability, as can be seen from the evaluation of the measured process values.

In addition, an optimization proposal 20 is still displayed on the screen 15. In this embodiment example, the optimization proposal 20 consists of increasing the atomizer speed of the rotary atomizer from 50,000 rpm to 55,000 rpm. However, this is merely an example to illustrate the disclosure. The operator of the paint system can then adopt and implement the optimization proposal 20.

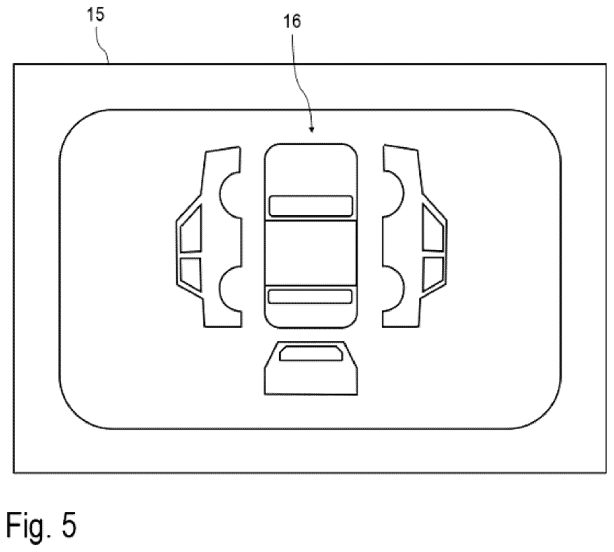

FIG. 5 shows a variation of FIG. 5 with a different body representation 16, which here is only two-dimensional and comprises two side views, a top view and a rear view. Otherwise, in order to avoid repetition, reference is made to the above description.

The disclosure is not limited to the preferred embodiments described above. Rather, a large number of variants and variations are possible which also make use of the idea of the disclosure and therefore fall within the scope of protection. In particular, the disclosure also claims protection for the subject matter and the features of the dependent claims independently of the claims referred to in each case and in particular also without the features of the main claim. The disclosure thus comprises different aspects of the disclosure which enjoy protection independently of each other.

1.-16. (canceled)

17. A method to operate a coating system that coats components with a coating agent with an applicator, comprising:
a) coating the components with the coating agent, wherein component-related process values are obtained which represent operating variables of devices of the coating system during the coating of the individual components, and wherein a specific component-related coating quality results during the coating of the individual components,
b) determining the component-related process values of the coating equipment,
c) determining the component-related quality values, the quality values reflecting the coating quality of the individual components, and
d) determining quality-relevant anomalies of the process values for detecting coating defects during the coating of the individual components in the context of a prediction operation during the coating of the components, and
e) determining the position of the coating defects corresponding to the anomalies on the component surface of the coated components by evaluating the process values.

18. The method according to claim 17, further comprising:
a) graphically representing the components in the form of a graphical component representation on a display screen, and
b) graphically marking the coating defect on the graphical component representation on the screen according to the position of the coating defect on the component surface.

19. The method according to claim 17, wherein the quality-relevant anomalies of the process values are determined in the course of the prediction operation by means of a machine-learning algorithm.

20. The method according to claim 19, wherein the determined quality-relevant anomalies of the process values are stored in a database together with the associated quality values.

21. The method according to claim 19, wherein the machine-learning algorithm is trained in the course of a training operation.

22. The method according to claim 20, wherein the training operation is carried out before the prediction operation.

23. The method according to claim 20, wherein the training operation is carried out during the prediction operation.

24. The method according to claim 21, further comprising the following for training the machine learning algorithm in the training operation:
a) determining the process values during a coating operation,
b) determining the associated quality values during the coating operation,
c) storing the determined process values and the determined quality values in a database,
d) training the machine-learning algorithm on the basis of the process values stored in the database and the quality values stored in the database.

25. The method according to claim 17, further comprising the following step: determining an optimization proposal for optimizing the process values to avoid the coating defect.

26. The method according to claim 18, wherein the graphical component representation on the screen is two-dimensional.

27. The method according to claim 18, wherein the graphical component representation on the screen is three-dimensional.

28. The method according to claim 17, wherein the process values are target values and/or actual values of the operating variables of the devices of the coating system.

29. The method according to claim 17, wherein the process values comprise at least one of the following operating variables:
a) drive variables of a robot drive for driving a coating robot,
b) path data of a robot movement,
c) pump variables of a coating agent pump,
d) operating variables of a metering piston of a metering pump,
e) pressure measured values of a pressure sensor,
f) valve variables of a valve,
g) operating variables of an air pressure regulator,
h) operating variables of a speed controller,
i) operating variables of a paint pressure controller,
j) operating variables of an electrostatic coating agent charging system,
k) operating variables of a booth air conditioning system of a coating booth,
l) wear variables,
m) actual values of proximity sensors,
n) type and characteristics of field bus participants, connection status or error counters of field bus systems,
o) actual values of temperature sensors,
p) fault messages from the equipment involved in the coating operation,
q) workpiece identification numbers to identify the components to be coated,
r) properties of the coating agent,
s) time stamp of the recording times of the operating variables.

30. The method according to claim 17, wherein
a) the components are each coated in coating tracks running next to one another, and
b) the process values relate in each case to the currently coated coating track and also to the adjacent coating tracks.

31. The method according to claim 17, wherein the quality values comprise at least one of the following variables:
a) number of the coating defects in the respective component,
b) position of the coating defects in space, in relation to the component or in relation to the coated partial surface,
c) type of the coating defects.

32. The method according to claim 17, wherein
a) the components to be coated are motor vehicle body components, and
b) the coating agent is a paint, and
c) the applicator is a print head or an atomizer.
